(19) United States
(12) Patent Application Publication
(10) Pub. No.: US 2020/0079703 A1
(43) Pub. Date: Mar. 12, 2020

(54) SOIL ENHANCEMENT

(71) Applicant: Khanh Le, San Jose, CA (US)

(72) Inventor: Khanh Le, San Jose, CA (US)

(21) Appl. No.: 16/355,125

(22) Filed: Mar. 15, 2019

Related U.S. Application Data
(63) Continuation-in-part of application No. 16/250,469, filed on Jan. 17, 2019.
Application No. 16/250,469 is a continuation-in-part of application No. 15/786,573, filed on Oct. 17, 2017, now Pat. No. 10,221,107.

(51) Int. Cl. C05F 11/08; C05G 3/00; C05C 1/02; C05F 1/00; C05F 3/02

(52) U.S. Cl. CPC C05F 11/08; C05G 3/0064; C05F 3/02; C05F 1/002; C05F 1/005; C05C 1/02

(57) ABSTRACT

Systems and methods are disclosed to provide plant nutrient by selecting a series of microbes optimal for plant growing; mixing the microbes, urea and humic acid in a mixture; and combining the mixture with a fertilizer.

### BACKGROUND

The present invention relates to microbial enhancements for soil.

Humic acids are a principal component of humic substances, which are the major organic constituents of soil (humus), peat and coal. It is also a major organic constituent of many upland streams, dystrophic lakes, and ocean water. It is produced by biodegradation of dead organic matter. It is not a single acid; rather, it is a complex mixture of many different acids containing carboxyl and phenolate groups so that the mixture behaves functionally as a dibasic acid or, occasionally, as a tribasic acid. Humic acids can form complexes with ions that are commonly found in the environment creating humic colloids. Humic acids are insoluble in water at acid pH, whereas fulvic acids are also derived from humic substances but are soluble in water across the full range of pH. Humic and fulvic acids are commonly used as a soil supplement in agriculture, and less commonly as a human nutritional supplement. As a nutrition supplement, fulvic acid can be found in a liquid form as a component of mineral colloids. Fulvic acids are poly-electrolytes and are unique colloids that diffuse easily through membranes whereas all other colloids do not.

In a parallel trend, bacterial agricultural microbes are helpful to the crops in a way that they detoxify the soil and fight the root diseases and provide stability to the soil system. They help in nitrogen fixation, phosphate solubilization, iron sequestration, and phytohormones level modulation in crops. Due to these factors, the bacterial segment dominates the agricultural microbial market.

### SUMMARY OF THE INVENTION

In one aspect, systems and methods are disclosed to provide plant nutrient by selecting a series of microbes optimal for plant growing; mixing the microbes, urea and humic acid in a mixture; and combining the mixture with a fertilizer.

In another aspect, systems and methods are disclosed to provide a plant nutrient by selecting a microbial solution with predetermined characteristics for agriculture use; iteratively and selectively breeding generations of microbes for microbial strain selection with predetermined microbial gene profiles to arrive at a predetermined microbial solution, wherein multiple single microbial series are separately cultivated and followed with cross cultivation among the microbial series in a specific sequence; and mixing by-products produced by the crossly cultivated microbial series with a fertilizer, a mineral or both.

In another aspect, systems and methods for enhancing soil includes selecting a microbial solution with predetermined characteristics for agriculture use; iteratively and selectively breeding generations of microbes for microbial strain selection with predetermined microbial gene profiles to arrive at a predetermined microbial solution, wherein multiple single microbial series are separately cultivated and followed with cross cultivation among the microbial series in a specific sequence; and mixing by-products produced by the crossly cultivated microbial series with fertilizer or mineral or both.

In another aspect, a pill, pellet, or solid can be made by selecting a microbial solution with predetermined characteristics for agriculture use; iteratively and selectively breeding generations of microbes for microbial strain selection with predetermined microbial gene profiles to arrive at a predetermined microbial solution in a highly concentrated form of at least 1×10⁷ cfu/ml (colony-forming units per milliliter), wherein multiple single microbial series are separately cultivated and followed with cross cultivation among the microbial series in a specific sequence; and mixing by-products produced by the crossly cultivated microbial series with humic acid and a filler.

In a further aspect, an agricultural system includes the above pill, pellet, or solid that is insertable into the ground along with the seed or after seed planting using a suitable agricultural implement such as a farm planter.

In yet another aspect, a method enhances soil by preparing a microbial solution with microbes, a growth medium; iteratively and selectively breeding generations of microbes to arrive at a predetermined microbial solution in a concentrated form of at least 1×10⁷ cfu/ml (colony-forming units per milliliter); and storing the microbial solution in a container for enriching the soil with micronutrients, microbial cultures and organic materials.

In another aspect, an apparatus for enhancing soil includes a tank for a microbial solution with microbes, a growth medium; a sequencer to iteratively and selectively breeding generations of microbes to arrive at a predetermined microbial solution in a highly concentrated form of at least 1×10⁷ cfu/ml (colony-forming units per milliliter); and a pump to dispense the microbial solution into a container to enrich the soil with micronutrients, microbial cultures and organic materials.

In a further aspect, an apparatus for enhancing soil includes a tank for a microbial solution with microbes, a growth medium, and water; a DNA sequencer to sample the microbial output and to guide the iteratively and selectively breeding of generations of microbes to arrive at a predetermined microbial solution in a highly concentrated form of at least 1×10⁷ cfu/ml (colony-forming units per milliliter); and a pump to dispense the microbial solution into a container to enrich the soil with micronutrients, microbial cultures and organic materials.

Implementations of the above aspects may include one or more of the following. The soil amendment or nutrient can be from any one of: Anhydrous Ammonia, Aqua Ammonia, Ammonium Nitrate, Ammonium Nitrate Solution, Ammonium Nitrate-Limestone Mixtures, Ammonium Nitrate—Sulfate, Ammonium Polysulfide, Ammonium Sulfate, Ammonium Sulfate Solution, Ammonium Sulfate—Nitrate, Ammonium Sulfate—Urea, Ammonium Thiosulfate, Calcium Ammonium Nitrate, Calcium Cyanamide, Calcium Nitrate, Calcium Nitrate—Urea, Ferrous Ammonium Sulfate, Magnesium Nitrate, Nitric Acid, Nitrogen, Sodium Nitrate, Sulfur Urea, Urea Solution, Urea—Formaldehyde, Zinc Ammonium Sulfate Solution, Zinc Manganese Sulfate, Nitrogen, Ammonium Metaphosphate, Ammonium Phosphate, Diammonium Phosphate, Ammonium Polyphosphate, Basic Lime Phosphate, Ammonium Phosphate Nitrate, Ammonium Phosphate Sulfate, Basic Slag, Monoammonium Phosphate, Bone Black Spent, Bone Meal, Raw, Bone Meal, Steamed, Bone, Precipitated, Calcium Metaphosphate, Colloidal Phosphate, Limestone, Phosphatic, Magnesium Phosphate, Nitric Phosphate, Phosphate Rock, Phosphoric Acid, Liquid Ammonium Polyphosphate, Precipitated Phosphate, Superphosphate, Normal, Superphosphate, Enriched, Superphosphate, Triple, Superphosphoric Acid, Phosphate Product, Phosphate, Lime-Potash Mixtures, Manure Salts, Potash Suspensions, Potassium Carbonate, Muriate of Potash, Potassium—Magnesium Sulfate, Potassium—Metaphosphate, Potassium Nitrate, Potassium—Sodium Nitrate, Potassium Sulfate, Tobacco Stems, Potash, Blood, Dried, Castor Pomace, Cocoa Shell Meal, Cocoa Tankage, Compost, Cottonseed Meal, Fish Scrap, Guano, Manure, Peat, Sewage Sludge, Activated, Sewage Sludge, Heat-Dried, Sewage Sludge, Other, Soybean Meal, Tankage, Animal, Tankage, Process, Linseed Meal, Tung Pumace, Aluminum Sulfate, Borax, Brucite or Magnesium Hydroxide, Cobalt Sulfate, Copper Oxide, Black, Copper Oxide, Red, Copper Sulfate, Copper Chelate, Copper Compound, Ferric Oxide, Ferric Sulfate, Ferrous Sulfate, Iron Chelate, Iron Compound, Gypsum or Calcium Sulfate, Calcium Chelate, Calcium Sulfate, Lime Sulfur Solution, Magnesia or Magnesium Oxide, Epsom Salt or Magnesium Sulfate, Magnesium Chelate, Manganese Agstone, Manganese Chelate, Manganese Oxide, Manganese Slag, Manganese Sulfate, Manganous Oxide, Sodium Molybdonate, Soil Additive, Soil Conditioner, Potting Soil, Sulfur, Calcium Chloride, Sulfuric Acid, Zinc Oxide, Zinc Oxysulfate, Zinc Sulfate, Zinc Sulfate Solution, Zinc Chelate, Calcium Oxide, Dolomite, Dolomitic Lime, Standard Calcite, Lime, Dolomitic & Calcitic Blend, Lime Suspensions, Water, Sand, and Non-Lime Filler.

In other embodiment, the microbes can be selected from one of: Bacillus (B.) acidiceler, B. acidicola, B. acidiproducens, B. acidocaldarius, B. acidoterrestrisr, B. aeolius, B. aerius, B. aerophilus, B. agaradhaerens, B. agri, B. aidingensis, B. akibai, B. alcalophilus, B. algicola, B. alginolyticus, B. alkalidiazotrophicus, B. alkalinitrilicus, B. alkalisediminis, B. alkalitelluris, B. altitudinis, B. alveayuensis, B. alvei, B. amyloliquefaciens, B. a. subsp. Amyl, aoliquefaciens, B. a. subsp. plantarum, B. amylolyticus, B. andreesenii, B. aneurinilyticus, B. anthracia, B. aquimaris, B. arenosi, B. arseniciselenatis, B. arsenicus, B. aurantiacus, B. arvi, B. aryabhattai, B. asahii, B. atrophaeus, B. axarquiensis, B. azotofixans, B. azotoformans, B. badius, B. barbaricus, B. bataviensis, B. beijingensis, B. benzoevorans, B. beringensis, B. berkeleyi, B. beveridgei, B. bogoriensis, B. boroniphilus, B. borstelensis, B. brevis Migula, B. butanolivorans, B. canaveralius, B. carboniphilus, B. cecembensis, B. cellulosilyticus, B. centrosporus, B. cereus, B. chagannorensis, B. chitinolyticus, B. chondroitinus, B. choshinensis, B. chungangensis, B. cibi, B. circulans, B. clarkii, B. clausii, B. coagulans, B. coahuilensis, B. cohnii, B. composti, B. curdlanolyticus, B. cycloheptanicus, B. cytotoxicus, B. daliensis, B. decisifrondis, B. decolorationis, B. deserti, B. dipsosauri, B. drentensis, B. edaphicus, B. ehimensis, B. eiseniae, B. enclensis, B. endophyticus, B. endoradicis, B. farraginis, B. fastidiosus, B. fengqiuensis, B. firmus, B. flexus, B. foraminis, B. fordii, B. formosus, B. fortis, B. fumarioli, B. funiculus, B. fusiformis, B. galactophilus, B. galactosidilyticus, B. galliciensis, B. gelatini, B. gibsonii, B. ginsengi, B. ginsengihumi, B. ginsengisoli, B. globisporus, B. g. subsp. globisporus, B. g. subsp. marinus, B. glucanolyticus, B. gordonae, B. gottheilii, B. graminis, B. halmapalus, B. haloalkaliphilus, B. halochares, B. halodenitrificans, B. halodurans, B. halophilus, B. halosaccharovorans, B. hemicellulosilyticus, B. hemicentroti, B. herbersteinensis, B. horikoshii, B. horneckiae, B. horti, B. huizhouensis, B. humi, B. hwajinpoensis, B. idriensis, B. indicus, B. infantis, B. infernus, B. insolitus, B. invictae, B. iranensis, B. isabeliae, B. isronensis, B. jeotgali, B. kaustophilus, B. kobensis, B. kochii, B. kokeshiiformis, B. koreensis, B. korlensis, B. kribbensis, B. krulwichiae, B. laevolacticus, B. larvae, B. laterosporus, B. lautus, B. lehensis, B. lentimorbus, B. lentus, B. licheniformis, B. ligniniphilus, B. litoralis, B. locisalis, B. luciferensis, B. luteolus, B. luteus, B. macauensis, B. macerans, B. macquariensis, B. macyae, B. malacitensis, B. mannanilyticus, B. marisflavi, B. marismortui, B. marmarensis, B. massiliensis, B. megaterium, B. mesonae, B. methanolicus, B. methylotrophicus, B. migulanus, B. mojavensis, B. mucilaginosus, B. muralis, B. murimartini, B. mycoides, B. naganoensis, B. nanhaiensis, B. nanhaiisediminis, B. nealsonii, B. neidei, B. neizhouensis, B. niabensis, B. niacini, B. novalis, B. oceanisediminis, B. odysseyi, B. okhensis, B. okuhidensis, B. oleronius, B. oryzaecorticis, B. oshimensis, B. pabuli, B. pakistanensis, B. pallidus, B. pallidus, B. panacisoli, B. panaciterrae, B. pantothenticus, B. parabrevis, B. paraflexus, B. pasteurii, B. patagoniensis, B. peoriae, B. persepolensis, B. persicus, B. pervagus, B. plakortidis, B. pocheonensis, B. polygoni, B. polymyxa, B. popilliae, B. pseudalcalophilus, B. pseudofirmus, B. pseudomycoides, B. psychrodurans, B. psychrophilus, B. psychrosaccharolyticus, B. psychrotolerans, B. pulvifaciens, B. pumilus, B. purgationiresistens, B. pycnus, B. qingdaonensis, B. qingshengii, B. reuszeri, B. rhizosphaerae, B. rigui, B. ruris, B. safensis, B. salarius, B. salexigens, B. saliphilus, B. schlegelii, B. sediminis, B. selenatarsenatis, B. selenitireducens, B. seohaeanensis, B. shacheensis, B. shackletonii, B. siamensis, B. silvestris, B. simplex, B. siralis, B. smithii, B. soli, B. solimangrovi, B. solisalsi, B. songklensis, B. sonorensis, B. sphaericus, B. sporothermodurans, B. stearothermophilus, B. stratosphericus, B. subterraneus, B. subtilis, B. s. subsp. inaquosorum, B. s. subsp. spizizenii, B. s. subsp. subtilis, B. taeanensis, B. tequilensis, B. thermantarcticus, B. thermoaerophilus, B. thermoamylovorans, B. thermocatenulatus, B. thermocloacae, B. thermocopriae, B. thermodenitrificans, B. thermoglucosidasius, B. thermolactis, B. thermoleovorans, B. thermophilus, B. thermoruber, B. thermosphaericus, B. thiaminolyticus, B. thioparans, B. thuringiensis, B. tianshenii, B. trypoxylicola, B. tusciae, B. validus, B. vallismortis, B. vedderi, B. velezensis, B. vietnamensis, B. vireti, B. vulcani, B. wakoensis, B. weihenstephanensis, B. xiamenensis, B. xiaoxiensis, and B. zhanjiangensis. With a member of Bacillus as the microbe, the process can use a carrier from one of: liquid, water, dry humic acid, wet humic acid, urea, soil wetting aid or a penetrant.

In one embodiment, the penetrant can be about 20% alcohol ethoxylate and about 80% orange oil. Alternatively, surfactants can be added. The penetrant can have one or more high terpene (50% by weight or more) based oils, one or more stabilizers, one or more chelating agents, one or more preservatives, one or more acidic pH adjusters and one or more organic solvents.

The microbes can be: Bacillus amyloliquefaciens, Bacillus lichniformis, Bacillus pumilus, or Bacillus subtilis, Bacillus megaterium. Leonardite and urea and water can be used with the microbes. Polyloxy—(1,2-Ethanedily), Alpha-(nonylphenyl)-omega-hydroxy can be used with the microbes. The solution can also include Leonardite and water. The microbial solutions can be applied through spraying, wetting, dipping, misting, drenching, showering, fogging, soaking, dampening, drizzling, dousing and splashing.

Advantages of the solutions may include one or more of the following. Soil enrichment feature of the system stimulates plant growth, rejuvenate the soil, and promote the growth of beneficial soil microorganisms. Some embodiments also provide natural pathogens for the prevention, control and/or cure of turf and plant diseases and other purposes encouraging germination and/or growth. The solutions contain microorganism spores and/or colonies that remain viable for at least about a year when stored at room temperature. The solutions provide soil enrichment solutions containing viable microorganism spores and/or colonies, particularly those useful for enriching poor, disturbed soils or soils having little or no microbial activity because of the heavy past use of chemicals and/or fertilizers. The systems provide solutions containing viable micro organism spores and/or colonies of beneficial fungicides that can be used for seed, turf, and leaf treatment for the prevention, control, and/or cure of turf and plant diseases and other beneficial purposes. The solutions also provide soil enrichment solutions containing microorganism spores and/or colonies that remain at least about 90% viable for up to at least about 12, preferably 18 months at room temperature, i.e., about 20° to 25° C.

These and other advantages are achieved by the present invention, which provides a method of preserving and solutions containing microbial spores and/or colonies.

### BRIEF DESCRIPTION OF THE FIGURES

FIGS. 1A-1C show exemplary processes to selectively breed the microbes for agricultural use.

FIGS. 2A-2B show exemplary processes to produce the microbial products.

FIGS. 3A-3B show exemplary antifungal activity express by different Bacillus spp. strains.

FIG. 4 shows exemplary cellulolytic enzymes synthesized by the biological control agent which can be involved in two plant defense mechanism against phyto-pathogenic fungi.

FIG. 5 shows exemplary soil enhancement enzyme profiles isolation standards.

### DETAILED DESCRIPTION OF THE INVENTION

A selectively bred microbial solution is disclosed with multiple single microbial series separately cultivated and followed with cross cultivation among those microbial series in a specific sequence and contains each of those microbial series, and by-products produced by those crossly cultivated microbial series are used for applications in modifying soil quality, activating soil, effectively degrading soil pollution, and helping growth of crops in a soil enhancement embodiment. After the selective breeding through the fermentation, the selectively bred naturally-occurring microorganisms have the ability to penetrate through the soil while enriching with micronutrients, microbial cultures and organic materials in a highly concentrated stage.

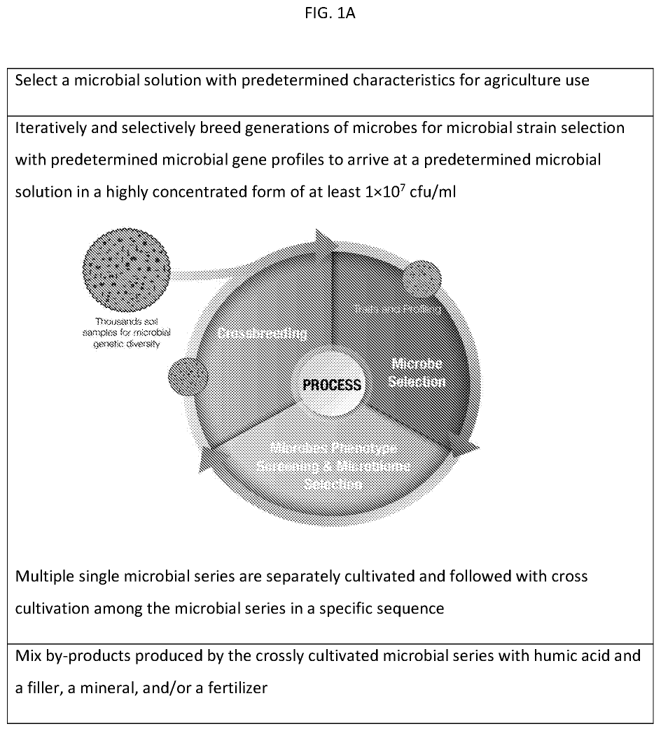

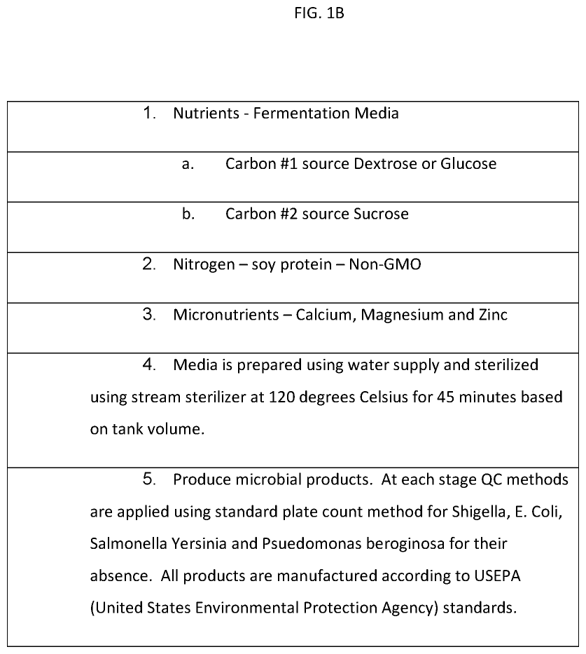

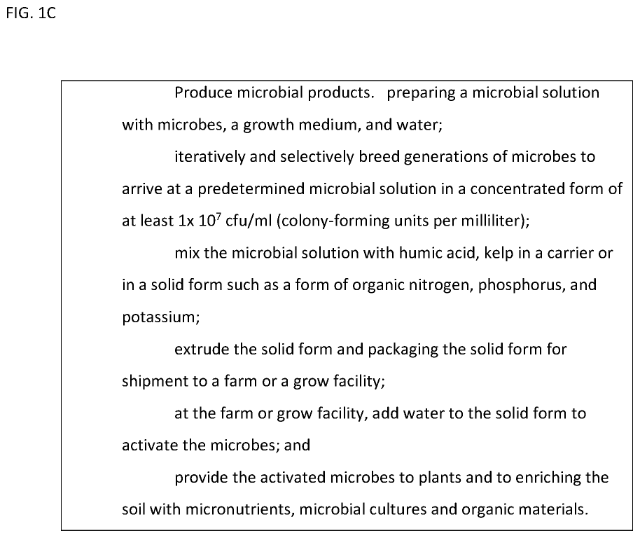

FIG. 1A shows an exemplary process to supplement soil. The process selects a microbial solution with predetermined characteristics for agriculture use. For example, the characteristics can focus on microbes that work on nitrogen fixing or production in the soil. Next, the process iteratively and selectively breeds generations of microbes for microbial strain selection with predetermined microbial gene profiles to arrive at a predetermined microbial solution in a highly concentrated form of at least 1×10⁷ cfu/ml in one embodiment and in other embodiment of at least 1×10⁹ cfu/ml. This process can be aided using DNA sequencing analysis to guide the production of the generations of microbes. The multiple single microbial series are separately cultivated and followed with cross cultivation among the microbial series in a specific sequence. Once the microbial population has arrived, the process mixes by-products produced by the crossly cultivated microbial series with humic acid and a filler such as kelp. Other additives such as fertilizer including PNK chemical can be added. The entire batch can be in liquid form, but preferably the water component is removed, leaving the pellets or solid products that can be planted into the soil.

Once implanted, the humic acid binds or attaches soil to the fertilizer and microbes. The microbes in turn help the plant to absorb the fertilizer and result in significant root growth, leading to plant growth. A major benefit is that the fertilizer is localized to the root due to the humic acid binding to minimize chemical runoffs, which pollute downstream water bodies, rivers, or lakes.

FIG. 1B shows an exemplary process to selectively breed the microbes for agricultural use. First, fermentation media are prepared with a nutrient supply (1). The nutrients can include a carbon source Dextrose or Glucose. Additional carbon sources can be used with the dextrose or glucose singly or in combination. For example, another carbon source can be sucrose, for example. Next, a nitrogen source is provided such as soy protein that has not been genetically modified (2). Next, in (3), micronutrients—Calcium, Magnesium and Zinc are provided. A person of ordinary skilled in the art appreciates that various compositions of the fermentation media can be prepared so long as the nutrients, one or more of the carbon sources, and the micronutrients are included.

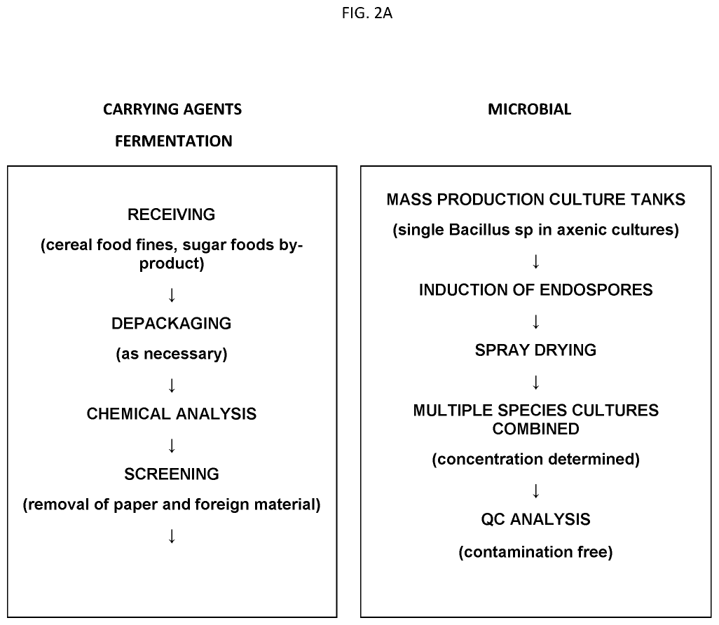

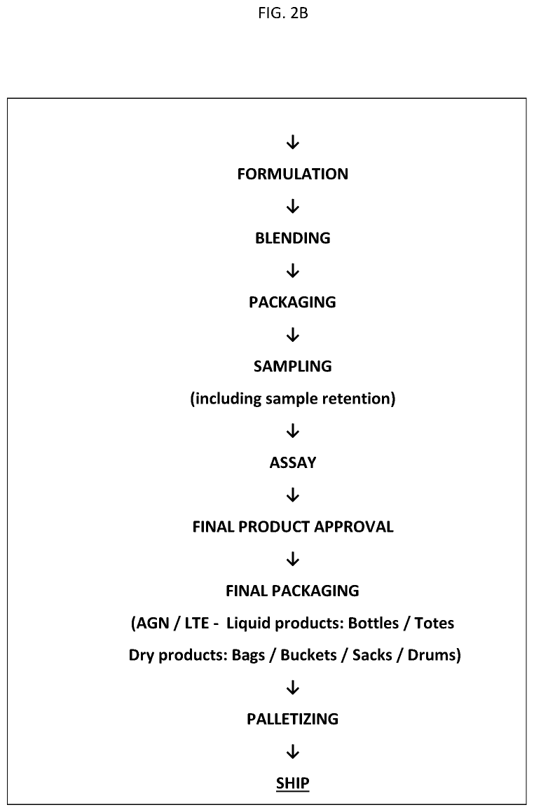

In (4), the fermentation media is prepared using water supply and sterilized using stream sterilizer at 120 degrees Celsius for 45 minutes, but the temperature and time can be varied in accordance with tank volume. In (5), the process produces the microbial products, as is detailed in FIG. 2. At each stage, quality control methods are applied using standard plate count method for Shigella, E. Coli, Salmonella Yersinia and Psuedomonas beroginosa for their absence. All products are manufactured according to USEPA (United States Environmental Protection Agency) standards.

The microbes can be: Bacillus amyloliquefaciens at 5.85×10⁷ cfu/ml, Bacillus licheniformis at 1.80×10⁷ cfu/ml, Bacillus megaterium 2.5×10⁸ CFU/ml, Bacillus pumilus at 4.05×10⁷ cfu/ml, or Bacillus subtilis at 6.30×10⁷ cfu/ml. Leonardite and urea and water can be used with the microbes. Polyloxy—(1,2-Ethanedily), Alpha-(nonylphenyl)-omega-hydroxy can be used with the microbes. The solution can also include Leonardite and water.

The Microbial Strain selection and profile of microbial genes are carefully selected to form the formulation of products. Through strain selections, screening and improvement, the system generates various bio-fertilizer products for rejuvenating soil and promote plant growth. For example, Bacillus Subtilus has 4,100 genes. These genes each contain approximately 2000 traits. In turn, each one of these traits and its mutation has over 1000 profiles and sub-profiles.

With a member of Bacillus as the microbe, the process can include a carrier from one of: liquid, water, dry humic acid, wet humic acid, urea, soil wetting aid, or a penetrant. When applied in the field to plants, billions of the selectively bred bacteria operate to covert and breakdown organic matter into a form of micronutrient for plant uptake. The microbial solution can be applied through spraying, wetting, dipping, misting, drenching, showering, fogging, soaking, dampening, drizzling, dousing and splashing.

The biodiversity of Bacillus group and beneficial traits of bacillus species are useful in plant protection. Bacillus genus is widely spread in nature. Bacillus species such as B. Subtilus, B. Megaterium, B. Amyloliquefaciens, B. lichniformis are carefully selected, for their specific profile which contains beneficial traits for plant protection and growth promotion that comprise the synthesis in broad-spectrum with active metabolites and easily adaptation in various environment conditions that benefit plant bacterial interaction and advantageous of formulation process.

As plants roots exudates and lysates attract and stimulate microbial activity in the root surrounding soil, the zhizosphere (chemical space around the roots) became highly populated. Beneficial Bacillus spp. strains can compete with other bacteria and fungi that could adversely affect crops. They can inhibit phytopathogenic attacks such as “Basal Stem Rot, phytophthora, fusarium”, or induce host-plant defense system against potential pathogenic attacks, stimulate plant growth, improve nutrient uptake, and reduce negative environment traits.

Beneficial traits with an agricultural purpose in Bacillus Subtilis and related species are detailed next. The species of bacillus group, particularly B. Subtilus, B. Megaterium, B. Amyloliquefaciens, B. lichniformis are extremely importance in agriculture, as phytopathogenic antagonist or plant growth promoters. It is often referring as “Plant Growth Promoting rhizobacteria “or PGPR. PGPR are naturally occurring soil bacteria that have the ability to colonize the roots, and the high concentration and the number of bacteria artificially created (added) as detailed above enhances the stimulation of plant growth by phytohormones production or by releasing beneficial organic compounds.

Beside plant growth stimulation, Bacillus Subtilis and its related species strain are involved in plant protection against phyto-pathogenic attacks. They act directly against pathogens by producing extracellular lytic enzyme and secondary metabolites with inhibitory growth action or interfere by quorum quenching to disturb cell-to-cell communication of the infectious expression in pathogenic bacteria. They could also compete with plant pathogen for the available nutrient and niche. Another important role is the reduction of the infection process by inducing a defense response in the host plant.

Each single microbial series is separately cultivated in its designated cultivation medium, and the optimal pH in the growing and reproduction of different microbial series also varies. Therefore, proper control and regulation of pH of the cultivation medium are provided in the course of bacterial cultivation and fermentation. The microbial series acquires energy through aerobic respiration. However, the aerobic respiration generally has to rely upon only the oxygen dissolved in the cultivation medium, i.e., the dissolved oxygen, and the containment of the dissolved oxygen in the cultivation medium is not always provided in sufficient amount and will be soonest consumed by bacteria since oxygen is difficult to get dissolved in water. Therefore, constant air supply to the microbial series is provided without interruption in the course of the cultivation and fermentation of the microbial series. Compositions of cultivation medium selected and the optimal growing environment conditions for each microbial series are detailed as follows:

When the cultivation of each microbial series is saturated in its cultivation medium, cross cultivation is followed. The compound microbial preparation differs from a single bacteria species or a single microbial product for soil modification. In some embodiments, the microbial life activities from multiple preselected microbial series are provided that are mutually coordinated and contained for crops or plants to get the results of specific fertilizers; that is, multiple microorganisms are screened from the soil and selectively bred to become capable of improving nutrition of the crops, and then to provide nitrogen, phosphor, and potassium fertilizers important to the growth of the plants in organic means by taking advantage of interaction among compound microbial preparations. Wherein, the nitrogen fixing series fixes nitrogen molecules in the nature to make it a nitrogen source for manufacturing fertilizers; the phosphoric acid releasing series unlocks and converts insolvable phosphates in the soil into phosphor, ferrous, and calcium fertilizers; the yeast group series makes it available in the making of vitamins and growing hormones, and decomposes organics to improve disease-resistant sufficiency of the plants; the photosynthetic bacteria series while being applied in manufacturing of glucose secrets carotenoid and eliminates toxic substances including hydrogen sulfide and ammonia; the actinomyces series secrets antibiotic substances at a constant amount on long-term bases to inhibit diseases; and the growing factors producing series also releases on long-term basic a given amount of growing hormones to promote roots, stalks and leaves of crops or plants to grow strong. In some embodiments, one or more of the above described series of microbials are used.

In the course of cross cultivation, each of those eight microbial series maintains intrigue symbiosis and shared prosperity among one another by playing a critical role with secretions of its own particular active organics. For example, the nitrogen fixing series converts the molecular nitrogen into ammoniac nitrogen and the resultant ammoniac nitrogen is partially to be consumed by the nitrogen fixing series, the remaining ammoniac nitrogen is synthesized into organic nitrogen to be consumed by other bacterial series; and the yeast group series may catalyze polysaccharide into simple sugar including glucose to be consumed by lactobacillus to convert into alcohol. Each microbial series supports activities of other microbial series with its synthetic proficiency while taking advantage of those substances produced by other microbial series to constitute a commonwealth circle. However, behind the big chain of food that relies on symbiosis substances, a survival game of gigantic resistance and wipe out takes place among one another due to different properties. In the environment seeing violent stimulation, new endocrines are produced. What's more important is that any strain of bacteria survived is practically the top selected one with reliable activities.

Depending on the locality, season, depth of soil, the present invention produces the proper strains of the microbial series. Those who are familiar with the art may apply on various series, e.g. coccus, bacillus, vibrio, or spirillum; different demands of oxygen, e.g., aerobic and/or anaerobic; different environmental requirements, e.g., acidophilus, alkalophilus, psycho-, meso-, or thermophilic to come up with a locality-specific compound microbial preparation and different microbial series may be used to produce compound microbial preparations in various applications, e.g., for fertilizer, pesticide, or promotion growth of flowers and fruits.

Spores and/or colonies that enrich soils and/or provide plant biological control agents are employed in some embodiments. These include bacteria such as Bacillus species, e.g., Bacillus subtilis, Bacillus cereus, Bacillus penetrans, Bacillus licheniformis, and Bacillus megaterium; fungi such as Trichoderma, e.g., Trichoderma hamatum, Trichoderma harzianum, Trichoderma polysporum, Trichoderma konigii, Trichoderma viride; yeast such as Saccharomyces cerevisiae; and mixtures of these. Other examples are given hereafter.

To guide the evolution of each generation of microbes, microbial whole-genome sequencing can be used for mapping genomes of novel organisms, finishing genomes of known organisms, or comparing genomes across multiple samples. Sequencing the entire microbial genome is important for generating accurate reference genomes, for microbial identification, and to guide whether the current microbial generation is better than the prior generation for particular characteristics or features for farming purposes. While capillary sequencing or PCR-based system can be used, next-generation sequencing (NGS) can sequence hundreds of organisms with the power of multiplexing. Unlike traditional methods, NGS-based microbial genome sequencing doesn't rely on labor-intensive cloning steps, saving time and simplifying the workflow. NGS can identify low frequency variants and genome rearrangements that may be missed or are too expensive to identify using other methods. De novo whole-genome sequencing involves assembling a genome without the use of a genomic reference and is often used to sequence novel microbial genomes. IIlumina sequencers can be used. Microbial whole-genome resequencing involves sequencing the entire genome of a bacteria, virus, or other microbe, and comparing the sequence to that of a known reference. Generating rapid and accurate microbial genome sequence information is critical for detecting low frequency mutations, finding key deletions and insertions, and discovering other genetic changes among microbial strains. A Library Preparation can be done before the sequencing and assembly. A Nextera DNA Flex Library Prep Kit or the TruSeq DNA PCR-Free Library Preparation Kits can be used. Benchtop sequencers such as the iSeq or nextSeq system can be used, or the High-Throughput Sequencing Systems such as the HiSeq 4000 System or the NovaSeq 6000 System can be used for throughput. Apps are then used for de novo assemblies or mapping of contigs and scaffolds. De novo assembly of bacteria using the Velvet assembler with a focus on Nextera Mate Pair data. An assembler performs a contig assembly, builds scaffolds, removes mate pair adapter sequences, and calculates assembly quality metrics. A Genome Assembler then assembles the microbial genome sequences. A Genome Annotation tool enables annotation of genes and coding sequences in prokaryotic genomes, from de novo assembly sequences.

Once the microbials are bred over generations to arrive at predetermined agricultural characteristics, they are mixed with humic acid, fertilizer and kelp fillers. Preferably the result is a solid or pellet that contains everything needed to be inserted into the soil to amend the soil. Humic substances are formed by the microbial degradation of dead plant matter, such as lignin and charcoal. Humic substances in the lab are very resistant to further biodegradation. The precise properties and structure of a given sample depend on the water or soil source and the specific conditions of extraction. Nevertheless, the average properties of lab produced humic substances from different sources are remarkably similar. Humic substances in soils and sediments can be divided into three main fractions: humic acids, fulvic acids, and humin. The humic and fulvic acids are extracted as a colloidal sol from soil and other solid phase sources into a strongly basic aqueous solution of sodium hydroxide or potassium hydroxide. Humic acids are precipitated from this solution by adjusting the pH to 1 with hydrochloric acid, leaving the fulvic acids in solution. This is the operational distinction between humic and fulvic acids. Humin is insoluble in dilute alkali. The alcohol-soluble portion of the humic fraction is, in general, named humic acid. So-called “gray humic acids” (GHA) are soluble in low-ionic-strength alkaline media; “brown humic acids” (BHA) are soluble in alkaline conditions independent of ionic strength; and fulvic acids (FA) are soluble independent of pH and ionic strength.

Humus in nature is produced by biodegradation of tissues from dead organisms and is thus roughly synonymous with organic matter; distinctions between the two are often not precisely and consistently made. Humic acid as traditionally produced in a laboratory is not a single acid; rather, it is a complex mixture of many different acids containing carboxyl and phenolate groups so that the mixture behaves functionally as a dibasic acid or, occasionally, as a tribasic acid. Humic acid used to amend soil is manufactured using these same well established procedures. Humic acids can form complexes with ions that are commonly found in the environment creating humic colloids. Humic acids are insoluble in water at acid pH, whereas fulvic acids are also derived from humic substances but are soluble in water across the full range of pH. Humic and fulvic acids are commonly used as a soil supplement in agriculture, and less commonly as a human nutritional supplement.[14] As a nutrition supplement, fulvic acid can be found in a liquid form as a component of mineral colloids. Fulvic acids are poly-electrolytes and are unique colloids that diffuse easily through membranes whereas all other colloids do not.

Humic substances are organic compounds that are important components of humus, the major organic fraction of soil, peat, and coal (and also a constituent of many upland streams, dystrophic lakes, and ocean water). Humic acids are organic substances extracted from soil that coagulate (form small solid pieces) when a strong-base extract is acidified, whereas fulvic acids are organic acids that remain soluble (stay dissolved) when a strong-base extract is acidified. Humic substances are high-molecular-weight macropolymers but as heterogeneous and relatively small molecular components of the soil organic matter auto-assembled in supramolecular associations and composed of a variety of compounds of biological origin and synthesized de novo by abiotic and biotic reactions in soil. It is the large molecular complexity of the soil humeome to confer to humic matter its bioactivity in soil and its role as plant growth promoter.

The kelp filler acts as a very high-quality organic fertilizer. With an N-P-K ratio of approximately 1-0-2, it is a good source of nitrogen and potassium. It also contains minerals, amino acids, and trace amounts of other micronutrients. Kelp meal is seaweed and is harvested from the ocean. Also known as sea kelp. It can be added to vegetable and flower gardens, potting mixes, and lawns. Seaweed or kelp filler, has a chelating ability and helps to release locked-up minerals in garden soil. Its high potash content aids in the formation of carbohydrates, is necessary for protein synthesis, promotes early growth, improves stem strength, and contributes to cold hardiness. As if that weren't enough, seaweed contains the hormones gibberellin and auxin, which function as growth enhancers. There are also beneficial vitamins, enzymes, and about 60 trace elements. A high alginic acid content combined with a low percentage of cellulose (the ingredient which gives land plants rigidity), causes its quick decomposition, facilitating its use as a compost accelerator. When applied to the soil, it stimulates soil bacteria, which increases fertility.

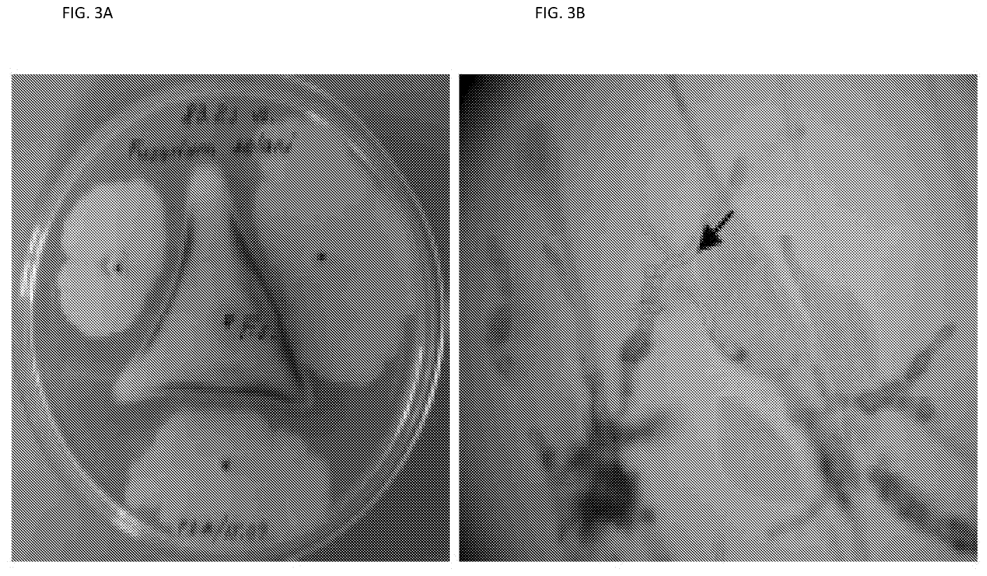

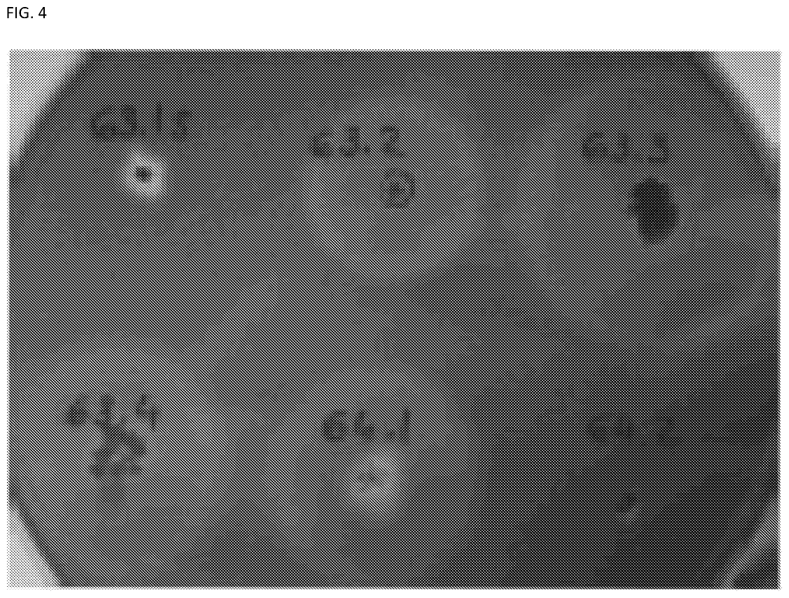

FIG. 3 shows exemplary antifungal activity express by different Bacillus spp. Strains. FIG. 3A shows exemplary Bacillus spp. antagonistic activity against fusarium solani; while FIG. 3B shows exemplary fungal cell wall degradation, cell lysis and cytoplasm bleeding due to Bacillus spp. extracellular enzymes.

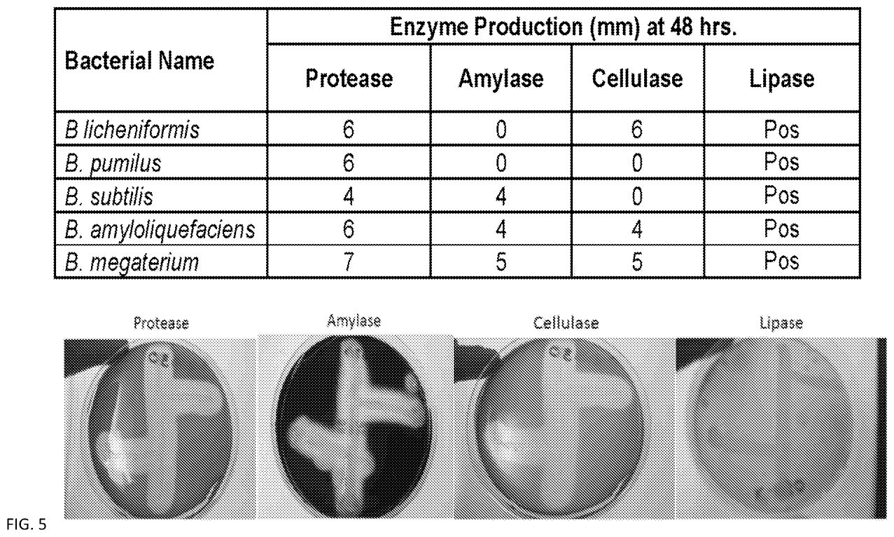

FIG. 4 shows exemplary cellulolytic enzymes synthesized by the biological control agent which can be involved in two plant defense mechanism against phyto-pathogenic fungi. Exemplary cellulase activity exposed on Luria Bertani medium supplement with carboxyl-methyl cellulose, reveal a clear halo of CMC degradation, after two days of Bacillus spp. strains incubation.

In one embodiment called AGN, a natural microbial soil rejuvenation and enrichment provides microbials including enzymes, metabolites and beneficial microbial biomass that aid in building soil structure. In this embodiment, the concentration of microbes can include the following:

| | | |
|---|---|---|
| Bacillus amyloliquefaciens | 5.85 × 10⁷ | cfu/ml |
| Bacillus licheniformis | 1.80 × 10⁷ | cfu/ml |
| Bacillus pumilus | 4.05 × 10⁷ | cfu/ml |
| Bacillus subtilis | 6.30 × 10⁷ | cfu/ml |
| Bacillus megaterium | 2.5 × 10⁸ | CFU/ml |

and the penetrant can be water with Polyloxy—(1,2-Ethanedily), alpha-(nonylphenyl)-omega-hydroxy or Alcohol Ethoxylate.

The colony-forming unit (CFU or cfu) is a measure of viable bacterial or fungal cells. CFU measures only viable cells. For convenience the results are given as CFU/mL (colony-forming units per milliliter) for liquids, and CFU/g (colony-forming units per gram) for solids.

Humic Acid can be leonardite and water, and the penetrant can be water with Polyloxy—(1,2-Ethanedily), alpha-(nonylphenyl)-omega-hydroxy. Humic Acid provides the necessary amino acids and protein to support an active microbial population to support active and healthy plant growth.

Penetrants or non-ionic penetrants facilitate even water movement into the soil both horizontally and vertically while maintaining a very low volatility. In some embodiments, the penetrants comprises a surfactant, which can be used together with heptonic acid, alkyl polyglycoside, water soluble polyacrylamides (PAMs), and/or polysiloxane emulsion. In some embodiments, the penetrants are selected to maintain soil moisture level near to root zone of predetermined plants, prevent leaching of nutrients, or both. Other surfactants can be used in various embodiments, for example: Nonionic surfactants include agents such as sorbitan monolaurate, sorbitan monopalmitate, sorbitan sesquioleate, sorbitan trioleate, polyoxyethylene sorbitan monolaurate, polyoxyethylene sorbitan monostearate, polyethylene glycol monooleate, polyethylene glycol alkylate, polyoxyethylene alkyl ether, polyglycol diether, lauroyl diethanolamide, fatty acid iso-propanolamide, maltitol hydroxy fatty acid ether, alkylated polysaccharide, alkyl glucoside, sugar ester, oleophillic glycerol monostearate, self-emulsifiable glycerol monostearate, polyglycerol monostearate, polyglycerol alkylate, sorbitan monooleate, polyethylene glycol monostearate, polyoxyethylene sorbitan monooleate, polyoxyethylene cetyl ether, polyoxyethylene sterol, polyoxyethylene lanolin, polyoxyethylene bees wax, and polyoxyethylene hydrogenated castor oil; and the like. Anionic surfactants include agents such as sodium stearate, potassium palmitate, sodium cetyl sulfate, sodium lauryl phosphate, sodium polyoxyethylene lauryl sulfate, triethanolamine palmitate, polyoxyethylene sodium lauryl phosphate, and sodium N-acyl glutamate; and the like. Cationic surfactants include agents such as stearyl dimethylbenzyl ammonium chloride, stearyl trimethyl ammonium chloride, benzalkonium chloride, and laurylamine oxide; and the like.

In one embodiment, the penetrant can be about 20% alcohol ethoxylate and about 80% orange oil. The penetrant can have one or more high terpene (50% by weight or more) based oils, one or more stabilizers, one or more chelating agents, one or more preservatives, one or more acidic pH adjusters and one or more organic solvents.

Surfactants can be used. Nonionic surfactants include agents such as sorbitan monolaurate, sorbitan monopalmitate, sorbitan sesquioleate, sorbitan trioleate, polyoxyethylene sorbitan monolaurate, polyoxyethylene sorbitan monostearate, polyethylene glycol monooleate, polyethylene glycol alkylate, polyoxyethylene alkyl ether, polyglycol diether, lauroyl diethanolamide, fatty acid iso-propanolamide, maltitol hydroxy fatty acid ether, alkylated polysaccharide, alkyl glucoside, sugar ester, oleophillic glycerol monostearate, self-emulsifiable glycerol monostearate, polyglycerol monostearate, polyglycerol alkylate, sorbitan monooleate, polyethylene glycol monostearate, polyoxyethylene sorbitan monooleate, polyoxyethylene cetyl ether, polyoxyethylene sterol, polyoxyethylene lanolin, polyoxyethylene bees wax, and polyoxyethylene hydrogenated castor oil; and the like. Anionic surfactants include agents such as sodium stearate, potassium palmitate, sodium cetyl sulfate, sodium lauryl phosphate, sodium polyoxyethylene lauryl sulfate, triethanolamine palmitate, polyoxyethylene sodium lauryl phosphate, and sodium N-acyl glutamate; and the like. Cationic surfactants include agents such as stearyl dimethylbenzyl ammonium chloride, stearyl trimethyl ammonium chloride, benzalkonium chloride, and laurylamine oxide; and the like. Amphoteric surfactants such as alkylaminoethyl glycine chloride and lecithin; and the like.

To deploy, field persons mix AGN with clean water and let it set for a minimum of 1 hour or maximum overnight (keep air flows after mixed with water) and apply directly to moist soil as a pre-plant, post-plant or seasonal treatment. The solution can be applied to soil, seeds, and plants. In some embodiments, the solution is not mixed with any other fertilizers or fungicides and deployment of such chemicals should wait at least 72 hours before or after treatment.

For tank mixing, in one embodiment, field personnel can mix 1 gallon (4 quarts or 3.8 liters) of AGN with minimum 100 gallons up to 1000 gallons of clean water in a clean tank and free of chemical. The solution can be applied at a rate of 2 to 4 quarts per surface acre or 4 to 8 liters per surface hectare.

For injection irrigation or fertigation, after tank mixing, AGN can be applied by dosage rate of 0.5 to 1 gallon (2 to 4 quarts) per surface acre (4 to 8 liters per surface hectare). For side-dress or starter, the solution can be applied at a rate of 1 to 2 quarts per surface acre or 2 to 4 liters per surface hectare. Preferably, the solution can be dispensed with:
Localized Drip or Trickle
Sprinkler, or
Contour Furrows

AGN includes Advanced Microbes for Soil Rejuvenation and creates a balanced soil environment for healthy plant growth which requires the ability to fully access the soil particulates and enriching them with phytonutrients utilizing highly concentrated microorganisms and organic materials.

The application of AGN creates superior root systems which can efficiently assimilate nutrients and micronutrients in the soil, resulting in higher yields and better plant health for all types of plants, crops, and trees and increases yields, soil-root-plant health, balance soil nutrients, penetrate and loosen clay soils, leach salts from root zones, reduce harmful nematodes, increase nutrient and micronutrient uptake as well as increase cathode ion transfer.

Any microbial spores and/or colonies can be preserved using methods and solutions of some embodiments. Spores and/or colonies of beneficial soil and plant pathogen biological control microorganisms are preferred. Microorganisms that grow rapidly and colonize substrata in soil after treatment with compositions of the invention are particularly preferred. These include, but are not limited to bacteria, e.g., Bacillus species such as Bacillus subtilis, Bacillus cereus, Bacillus penetrans, Bacillus licheniformis, and Bacillus megaterium; fungi, e.g., Trichoderma species such as Trichoderma hamatum, Trichoderma harzianum, Trichoderma polysporum, Trichoderma konigii, and Trichoderma viride; and yeast species such as Saccharomyces cerevisiae. As illustrated below, mixtures of microorganisms can also be preserved, and are preferred in many embodiments. Examples are given hereafter.

In the practice of the system, spores or whole microorganisms, including harvested and/or lyophilized microbial colonies containing spores, are added to solutions. The solutions can be formulated for any use requiring viable microbial spores and/or colonies such as for fertilizers, composting, food products, and pharmaceutical compositions. Liquid fertilizers are preferred for soil enrichment purposes. Water miscible dry powders and/or granules such as lyophilized preparations of spores and/or colonies are preferred in many embodiments. The amount of spores or microorganisms added to solutions of the invention is not fixed per se, and necessarily is dependent upon the degree of soil and/or plant remediation required, the number and identity of microorganism species needed in the formulation, and the concentration of other ingredients in the formulation. Preferred embodiments employ spores and/or colonies in amounts effective to achieve recolonization of the soil by spray application of the composition. Typical embodiments contain sufficient spores and/or colonies to deliver from about 1000 to about 1,000,000 colony forming units (CFU) per square foot when the preparation is delivered.

Preservative solutions of some embodiments are colloidal in nature, containing humic acid and/or other organic macromolecules. By “colloidal” is meant a state of matter which comprises either large molecules, aggregations of smaller molecules, or a combination of the two. Some embodiments contain large molecules such as humic acid and/or methylene urea compounds of varying chain length. The particles are surrounded by different matter such that a dispersed phase is surrounded by an external phase. Both phases may be solid or liquid (and sometimes gaseous). One phase comprises water in most embodiments; typical ranges are from about 35% to about 58% by weight water in the total composition, but some embodiments contain less than about 20% by weight water in the total composition.

Microorganisms and/or their spores which can be preserved using formulations of the invention further exhibit a number of desirable characteristics related to soil enrichment and improvement of soil quality described above, such as biological control of plant pathogens (already mentioned); enhancement and/or production of desirable phtyohormones, e.g., auxins, giberillins and cytokinins; and solubilization of phosphates. Certain strains of Bacillus subtilis, for example, inhibit N. Galligena that colonize apple branch scars if applied to trees after leaf fall. E. herbicola and Pseudomonas isolates have been shown to partially control fire blight of pome fruit trees. Several Bacillus species produce antibiotics useful when sprayed as a leaf or needle application on tobacco, Douglas fir, and apple trees, and the natural protection of leaves provided by the buffering capacity of phylloplane microorganisms has been demonstrated. Azobacter, Rhizobium, Bacillus, Klebsiella, Azospirillium, Enterobacter, Serratia, Agrobacterium, Arthrobacter, Aerobacter, Actinomyces, Bacillus, Pseudomonas, and other bacteria stimulate growth, increase yield, and produce other positive results by various mechanisms including enhancing nutrient uptake, increasing germination, enhancing seedling emergence, stimulating de novo biosynthesis, and the like, when applied to fields of various food plants.

The resulting solutions supply carbon-rich organic materials in a bioavailable form for soils and plants together with nutrients that feed the microorganisms as they multiply after application. Solutions of some embodiments provide an excellent food source for the germination of spores and/or colonies when the solutions are applied to soil or water. It is a further advantage that preferred solutions contain a wide variety of naturally occurring metabolites that can be readily absorbed by the growing microorganisms and enhance seed germination, root development, and growth of plants in the soil.

As summarized above, some embodiments are formulated with microorganism spores and/or cultures useful in the prevention, control and/or cure of plant diseases, particularly those of fungal origin. Illustrative examples are provided hereafter. One embodiment, for example, maintains the viability of Bacillus subtilis GB03 (EPA Reg. No. 7501-144), a bacteria recognized to colonize developing root systems, suppressing disease organisms such as Fusarium, Rhizoctonia, Alternaria and Aspergillus that attack root systems. Compositions of the invention can be used to treat developed root systems as well as developing root systems. As the root system develops, grows, and functions, the bacteria grow with the roots, extending protection throughout the growing season. As a result of this biological protection, a vigorous root system can be established and maintained by the plants.

In addition, B. subtilisGB03 has been shown to increase the amount of nodulation by nitrogen-fixing bacteria when used on many legumes. This improvement in nodulation is a result of a healthier root system, allowing more sites for nodules to form from naturally-occurring soil borne nitrogen-fixing bacteria. Illustrative examples follow.

FIG. 5 shows an exemplary AGN enzyme profiles isolation standard. Soil bacteria in the genus Bacillus are well known for contributions to improving soil structure, nutrient availability and as a competitive excluder to harmful pathogens. Bacillus lichniformis produces a variety of extracellular enzymes that are associated with the cycling of nutrients in nature, thus improve nutrient availability and nutrient uptake. Bacillus pumilus is an agricultural fungicide. Growth of the bacterium on plant roots prevents rhizoctonia and fusarium spores from germinating. These strains are heavily involved with inhibition of opportunistic pathogens as well as improving nutrient availability and nutrient uptake. Bacillus subtilis does nitrogen fixing; produce inhibitory compounds that reduce the growth of harmful microorganism. It interfere with the germination of plant pathogen spores and their attachment to host plants, acts as a prebiotic conditioning plants own defense mechanisms prior to attack from potential pathogens. Bacillus amyloliquefaciens had anti fungal properties and help nitrogen fixing availability. Bacillius megaterium is a plant growth-promoting rhizobacteria (PGPR) and phosphate solubilizing. It promotes the activation of plant defense responses and secretion of plant growth-regulating substances such as auxins, cytokinins and bacterial volatiles. Phytohormones are involved in the control of growth and in almost every important developmental process in plants. Bacterial secretion of phytohormones can impact root architecture by overproduction of root hairs and lateral roots and subsequently increased nutrient and water uptake, thus contributing to growth.

In some examples, the method to provide plant nutrient includes selecting a microbial solution with predetermined characteristics for agriculture use; iteratively and selectively breeding generations of microbes for microbial strain selection with predetermined microbial gene profiles to arrive at a predetermined microbial solution, wherein multiple single microbial series are separately cultivated and followed with cross cultivation among the microbial series in a specific sequence.

### EXAMPLE 1 (AGN)

### Microbes:

Bacillus amyloliquefaciens at 5.0×10⁷ cfu/ml

Bacillus licheniformis at 1.0×10⁸cfu/ml

Bacillus subtilis at 5.0×10⁷ cfu/ml

Bacillus megaterium 1.0×10⁸CFU/ml
Humic Acid: Leonardite and H2O
Nitrogen: Urea and H2O
Penetrant: Polyloxy—(1,2-Ethanedily), Alpha-(nonylphenyl)-omega-hydroxy and H2O

### EXAMPLE 2 (AGN LTE)

Bacillus amyloliquefaciens at 7.5×10⁸ cfu/ml

Bacillus licheniformis at 7.5×10⁷ cfu/ml

Bacillus megaterium 2.5×10⁸CFU/ml

Bacillus subtilis at 1.0×10⁸cfu/ml
Humic Acid: Leonardite and H2O
In other examples, the method includes iteratively and selectively breeding generations of microbes for microbial strain selection with predetermined microbial gene profiles to arrive at a predetermined microbial solution wherein multiple single microbial series are separately cultivated and followed with cross cultivation among the microbial series in a specific sequence; and mixing by-products produced by the crossly cultivated microbial series with a soil amendment or nutrient. Such soil amendment or nutrient can be fertilizer, mineral, or a combination of both. In one embodiment, the inorganic fertilizer/amendment/nutrient can be:

| Fertilizer | Selected Microbes mixed with Source |
|---|---|
| Nitrogen (N) | organic fertilizers including animal manure, plant waste, |
| | seaweed, fishmeal, dried blood etc, give exchangeable |
| | nitrogen |
| | nitrogen fixing bacteria in soil or in symbiotic |
| | relationship with legumes |
| | nitrates, non-marine evaporates |
| | ammonia and its derivatives from petrochemical plants |
| Potash (K) | organic fertilizers, especially manure |
| | bittern salts of marine evaporites |
| Lime (Ca) | shells and bone |
| | carbonate rocks including limestone, tufa, calcrete |
| Phosphates (P) | bone meal, manure |
| | guano (consolidated droppings of sea birds, from oceanic |
| | islands, now largely worked out) |
| | superphosphate derived from phosphorus |
| | basic slag byproduct of steel production |
| Sulfur (S) | salt domes (reduction of gypsum) |
| | iron sulphides |

In other examples, the soil Fertilizer can be one of the following:

| FERTILIZER | N | P₂0 | K | RANGE | FORM |
|---|---|---|---|---|---|
| Anhydrous Ammonia | 82.0 | 0.0 | 0.0 | 80-83% N | Liquid |
| Aqua Ammonia | 20.5 | 0.0 | 0.0 | 10-30% N | Liquid |
| Ammonium Nitrate | 34.0 | 0.0 | 0.0 | 33-34% N | Dry |
| Ammonium Nitrate Solution | 20.0 | 0.0 | 0.0 | 18-20% N | Liquid |
| Amm Nitrate-Limestone | 20.5 | 0.0 | 0.0 | 17-26% N | Dry |
| Ammonium Nitrate - Sulfate | 30.0 | 0.0 | 0.0 | 26-30% N | Dry |
| Ammonium Polysulfide | 20.0 | 0.0 | 0.0 | 18-23% N | Liquid |
| Ammonium Sulfate | 21.0 | 0.0 | 0.0 | 20-21% N | Dry |
| Ammonium Sulfate Solution | 6.0 | 0.0 | 0.0 | 6-9% N | Liquid |
| Ammonium Sulfate - Nitrate | 26.0 | 0.0 | 0.0 | | Dry, liquid |
| Ammonium Sulfate - Urea | 33.5 | 0.0 | 0.0 | 33-34% N | Dry |
| Ammonium Thiosulfate | 12.0 | 0.0 | 0.0 | | Liquid |
| Calcium Ammonium Nitrate | 17.0 | 0.0 | 0.0 | 17-20.5% N | Dry, liquid |
| Calcium Cyanamide | 20.5 | 0.0 | 0.0 | | Dry, liquid |
| Calcium Nitrate | 15.5 | 0.0 | 0.0 | 15-15.5% N | Dry, liquid |
| Calcium Nitrate - Urea | 33.8 | 0.0 | 0.0 | 30-35% N | Dry |
| Ferrous Ammonium Sulfate | 7.0 | 0.0 | 0.0 | 14% FE, 16% S | Dry |
| Magnesium Nitrate | 7.1 | 0.0 | 0.0 | | Liquid |
| Nitric Acid | 15.0 | 0.0 | 0.0 | | Liquid |
| Nitrogen Solution <28% | 0.0 | 0.0 | 0.0 | <28.0% N | Liquid |
| Nitrogen Solution 28% | 28.0 | 0.0 | 0.0 | 28-29.9% N | Liquid |
| Nitrogen Solution 30% | 30.0 | 0.0 | 0.0 | 28-29.9% N | Liquid |
| Nitrogen Solution 32% | 32.0 | 0.0 | 0.0 | 32-32.9% N | Liquid |
| Nitrogen Solution >32% | 0.0 | 0.0 | 0.0 | >32.0% N | Liquid |
| Sodium Nitrate | 16.0 | 0.0 | 0.0 | | Dry |
| Sulfur Coated Urea | 36.0 | 0.0 | 0.0 | 36-38% N | Dry |
| Urea | 46.0 | 0.0 | 0.0 | 45-46% N | Dry |
| Urea Solution | 20.0 | 0.0 | 0.0 | | Liquid |
| Urea - Formaldehyde | 38.0 | 0.0 | 0.0 | 35-40% N | Dry |
| Zinc Ammonium Sulfate | 10.0 | 0.0 | 0.0 | 10-15% N, 10% Z, 5% S | Liquid |
| Zinc Manganese Amm | 14.0 | 0.0 | 0.0 | | Liquid, dry |

| FERTILIZER | N | P | K | RANGE | FORM |
|---|---|---|---|---|---|
| Nitrogen Product | 0.0 | 0.0 | 0.0 | 2-44% N | Dry, liquid |
| Nitrogen - Code/Grade | 0.0 | 0.0 | 0.0 | 2-44% N | Dry, liquid |
| Ammonium Metaphosphate | 12.0 | 51.0 | 0.0 | | Dry |
| Ammonium Phosphate | 11.0 | 48.0 | 0.0 | | Dry |
| Diammonium Phosphate | 18.0 | 46.0 | 0.0 | 18-21% N | Dry |
| Ammonium Polyphosphate | 15.0 | 60.0 | 0.0 | | Dry, liquid |
| Basic Lime Phosphate | 0.0 | 0.0 | 0.0 | 5-37% P205 | Dry |
| Ammonium Phosphate | 27.0 | 14.0 | 0.0 | | Dry |
| Ammonium Phosphate | 16.0 | 20.0 | 0.0 | | Dry, liquid |
| Basic Slag | 0.0 | 9.0 | 0.0 | 8-10% P205 | Dry, liquid |
| Monoammonium Phosphate | 11.0 | 52.0 | 0.0 | | Dry |
| Bone Black Spent | 1.0 | 33.0 | 0.0 | | Dry |
| Bone Meal, Raw | 3.9 | 22.0 | 0.0 | | Dry |
| Bone Meal, Steamed | 2.2 | 27.0 | 0.0 | | Dry |
| Bone, Precipitated | 0.0 | 35.0 | 0.0 | 28-45% P205 | Dry |
| Calcium Metaphosphate | 0.0 | 60.0 | 0.0 | 60-62% P205 | Dry |
| Colloidal Phosphate (Soft) | 0.0 | 2.0 | 0.0 | 2-8% P205 | Dry |
| Limestone, Phosphatic | 0.0 | 13.0 | 0.0 | 13-14% P205 | Dry |
| Magnesium Phosphate | 0.0 | 18.0 | 0.0 | 17-18% P205 | Dry |
| Nitric Phosphate | 0.0 | 0.0 | 0.0 | 14-22% N, 10-22% | Dry |
| Phosphate Rock | 0.0 | 3.0 | 0.0 | 2-4% P205 | Dry |
| Phosphoric Acid | 0.0 | 54.0 | 0.0 | 2-75% P205 | Liquid |
| Liquid Amm Polyphosphate | 10.0 | 34.0 | 0.0 | 5-12% N, 17-37% P205 | Liquid |
| Precipitated Phosphate | 0.0 | 35.0 | 0.0 | 24-45% P205 | Dry |
| Superphosphate, Normal | 0.0 | 22.0 | 0.0 | 18-22% P205 | Dry |
| Superphosphate, Enriched | 0.0 | 23.0 | 0.0 | 23-39% P205 | Dry |
| Superphosphate, Triple | 0.0 | 46.0 | 0.0 | 40-54% P205 | Dry |
| Superphosphoric Acid | 0.0 | 68.0 | 0.0 | 68-75% P205 | Liquid |
| Phosphate Product | 0.0 | 0.0 | 0.0 | 1-75% P205 | Dry, liquid |
| Phosphate | 0.0 | 0.0 | 0.0 | 1-75% P205 | Dry, liquid |

| FERTILIZER | N | P₂0 | K | RANGE | FORM |
|---|---|---|---|---|---|
| Lime-Potash Mixtures | 0.0 | 0.0 | 10.0 | 5-10% K20 | Dry |
| Manure Salts | 0.0 | 0.0 | 20.0 | 20-30% K20 | Dry |
| Potash Suspensions | 0.0 | 0.0 | 0.0 | | Liquid |
| Potassium Carbonate | 0.0 | 0.0 | 64.0 | 52-69% K20 | Dry, liquid |
| Muriate of Potash 60% | 0.0 | 0.0 | 60.0 | 59-61% K20 | Dry |
| Muriate of Potash 62% | 0.0 | 0.0 | 62.0 | | Dry |
| Potassium - Magnesium | 0.0 | 0.0 | 22.0 | 21-28% K20 | Dry |
| Potassium - Metaphosphate | 0.0 | 55.0 | 37.0 | | Dry |
| Potassium Nitrate | 14.0 | 0.0 | 44.0 | 12-14% N, 44-46% | Dry |
| Potassium - Sodium Nitrate | 15.0 | 0.0 | 14.0 | | Dry, liquid |
| Potassium Sulfate | 0.0 | 0.0 | 50.0 | 48-52% K20 | Dry |
| Tobacco Stems | 2.0 | 0.0 | 6.0 | | Dry |
| Potash Product | 0.0 | 0.0 | 0.0 | 0-47% K20 | Dry, liquid |
| Potash - Code/Grade Unknown | 0.0 | 0.0 | 0.0 | 0-47% K20 | Dry, liquid |
| Blood, Dried | 12.0 | 0.0 | 0.0 | | Dry |
| Castor Pomace | 5.0 | 1.0 | 1.0 | | Dry |
| Cocoa Shell Meal | 2.5 | 1.0 | 2.0 | | Dry |
| Cocoa Tankage | 4.0 | 1.5 | 2.0 | | Dry |
| Compost | 2.0 | 2.0 | 1.0 | | Dry |
| Cottonseed Meal | 6.4 | 2.0 | 1.0 | | Dry |
| Fish Scrap | 6.0 | 6.0 | 6.0 | | Dry |
| Guano | 12.0 | 11.0 | 2.0 | | Dry |
| Manure | 0.5 | 0.5 | 0.5 | | Dry |
| Peat | 1.9 | 0.2 | 0.2 | | Dry |
| Sewage Sludge, Activated | 6.0 | 2.0 | 2.0 | | Dry, liquid |
| Sewage Sludge, Heat-Dried | | | | | Dry |
| Sewage Sludge, Other | 6.0 | 2.0 | 1.0 | | Dry, liquid |
| Soybean Meal | 6.0 | 1.0 | 2.0 | | Dry |
| Tankage, Animal | 8.1 | 5.3 | 5.9 | | Dry |
| Tankage, Process | 7.8 | 0.0 | 0.0 | | Dry |
| Linseed Meal | 5.6 | 2.0 | 1.0 | | Dry |

| FERTILIZER | N | P₂ | K | RANGE | FORM |
|---|---|---|---|---|---|
| Tung Pumace | 8.0 | 2.0 | 2.0 | | Dry |
| Natural Org- | 0.0 | 0.0 | 0.0 | | Dry |
| Natural Org-Code/Grade | 0.0 | 0.0 | 0.0 | | Dry |
| Aluminum Sulfate | 0.0 | 0.0 | 0.0 | | Dry |
| Borax | 0.0 | 0.0 | 0.0 | | Dry |
| Brucite (Magnesium Hydroxide) | 0.0 | 0.0 | 0.0 | | Dry |
| Cobalt Sulfate | 0.0 | 0.0 | 0.0 | | Dry |
| Copper Oxide, Black | 0.0 | 0.0 | 0.0 | | Dry |
| Copper Oxide, Red | 0.0 | 0.0 | 0.0 | | Dry |
| Copper Sulfate | 0.0 | 0.0 | 0.0 | | Dry |
| Copper Chelate | 0.0 | 0.0 | 0.0 | | Liquid, dry |
| Copper Compound | 0.0 | 0.0 | 0.0 | | Liquid, dry |
| Ferric Oxide | 0.0 | 0.0 | 0.0 | | Dry |
| Ferric Sulfate | 0.0 | 0.0 | 0.0 | | Dry |
| Ferrous Sulfate | 0.0 | 0.0 | 0.0 | | Dry |
| Iron Chelate | 0.0 | 0.0 | 0.0 | | Dry, liquid |
| Iron Compound | 0.0 | 0.0 | 0.0 | | Dry, liquid |
| Gypsum (Calcium Sulfate) | 0.0 | 0.0 | 0.0 | | Dry |
| Calcium Chelate | 0.0 | 0.0 | 0.0 | | Dry, liquid |
| Calcium Sulfate (Hydrous) | 0.0 | 0.0 | 0.0 | | Dry, liquid |
| Lime Sulfur Solution | 0.0 | 0.0 | 0.0 | | Liquid |
| Magnesia (Magnesium Oxide) | 0.0 | 0.0 | 0.0 | | Dry |
| Epsom Salt (Magnesium Sulfate) | 0.0 | 0.0 | 0.0 | | Dry |
| Magnesium Chelate | 0.0 | 0.0 | 0.0 | | Dry, liquid |
| Manganese Agstone | 0.0 | 0.0 | 0.0 | | Dry |
| Manganese Chelate | 0.0 | 0.0 | 0.0 | | Dry, liquid |
| Manganese Oxide | 0.0 | 0.0 | 0.0 | | Dry |
| Manganese Slag | 0.0 | 0.0 | 0.0 | | Dry |
| Manganese Sulfate | 0.0 | 0.0 | 0.0 | | Dry |
| Manganous Oxide | 0.0 | 0.0 | 0.0 | | Dry |
| Sodium Molybdonate | 0.0 | 0.0 | 0.0 | | Dry |
| Soil Amendment | 0.0 | 0.0 | 0.0 | | Dry, liquid |

| FERTILIZER | N | P₂0 | K2 | RAN | FORM |
|---|---|---|---|---|---|
| Soil Additive | 0.0 | 0.0 | 0.0 | | Dry, liquid |
| Soil Conditioner | 0.0 | 0.0 | 0.0 | | Dry, liquid |
| Potting Soil | 0.0 | 0.0 | 0.0 | | Dry |
| Sulfur | 0.0 | 0.0 | 0.0 | | Dry, liquid |
| Calcium Chloride | 0.0 | 0.0 | 0.0 | | Dry, liquid |
| Sulfuric Acid | 0.0 | 0.0 | 0.0 | | Liquid |
| Zinc Oxide | 0.0 | 0.0 | 0.0 | | Dry |
| Zinc Oxysulfate | 0.0 | 0.0 | 0.0 | | Dry |
| Zinc Sulfate | 0.0 | 0.0 | 0.0 | | Dry |
| Zinc Sulfate Solution | 0.0 | 0.0 | 0.0 | | Liquid |
| Zinc Chelate | 0.0 | 0.0 | 0.0 | | Dry, liquid |
| Sec./Micro- | 0.0 | 0.0 | 0.0 | | Dry, liquid |
| Sec./Micro-Code/Grade | 0.0 | 0.0 | 0.0 | | Dry, liquid |
| Calcium Oxide (Burnt) | 0.0 | 0.0 | 0.0 | | Dry |
| Calcium Hydroxide (Hydrate) | 0.0 | 0.0 | 0.0 | | Dry |
| Standard Dolomite | 0.0 | 0.0 | 0.0 | | Dry |
| Dolomitic Lime (75% Neutral) | 0.0 | 0.0 | 0.0 | | Dry, liquid |
| Standard Calcite | 0.0 | 0.0 | 0.0 | | Dry |
| Calcitic Lime (75% Neutral) | 0.0 | 0.0 | 0.0 | | Dry, liquid |
| Lime Product- | 0.0 | 0.0 | 0.0 | | Dry |
| Lime Product-Code/Grade | 0.0 | 0.0 | 0.0 | | Dry |
| Dolomitic & Calcitic | 0.0 | 0.0 | 0.0 | | Dry |
| Blend (Pelletized) | | | | | |
| Lime Suspensions | 0.0 | 0.0 | 0.0 | | Liquid |
| Non-Lime Filler (Water, Sand, | 0.0 | 0.0 | 0.0 | | Dry, liquid |

In one embodiment, a method to provide plant nutrient includes selecting a series of microbes optimal for plant growing; mixing the microbes, urea and humic acid in a mixture; and combining the mixture with a fertilizer. The fertilizer can be an inorganic fertilizer, as indicated above, or can be an organic fertilizer such as compost, manure, blood meal, bone meal, bat guano, shellfish, rock phosphate, greensand, fish emulsion, and chitin, among others

Manure for the garden comes from cow, sheep, poultry and horses. Pretty self-explanatory. Manure is known as a “complete” fertilizer; it has a lot of organic matter, but is low in nutrients. Manures are most valuable as organic soil amendments and mulches. Note: Beware of using fresh manure as a fertilizer because it can burn plants.

Blood meal is dried, powdered blood collected from cattle slaughterhouses. It's such a rich source of nitrogen that gardeners have to be careful not to over-apply and burn the roots of their plants. Apply blood meal just before planting to stimulate green leafy growth.

Bone meal is finely ground bone. A by-product from animal slaughterhouses, it is a great source of calcium and contains up to 15% phosphate. Bone meal promotes strong root systems and flowering. It is often used when growing flowers, bulbs and fruit trees.

Bat guano is protected by caves from leaching, so nutrients are conserved. It is rich in soluble nitrogen, phosphorous and trace elements. Usually powdery, bat guano may be used any time of year as a top dressing or diluted in a tea and used as a foliar spray. South American seabird guano is among the world's best. It is gathered off the rocks of arid sea islands, where rainfall and decomposition is minimal. As a result, seabird guano is very high in nitrogen, phosphorous and other nutrients. At Planet Natural, we offer all kinds of garden supplies, including guanos, which provide plant nutrients in a natural form.

Shellfish fertilizer or shell meal is made from crushed bones or shells from crab or other shellfish. It is a great source of calcium in addition to phosphorus and many trace minerals. One benefit of shellfish fertilizer: it contains chitin which encourages the growth of organisms that inhibit harmful pest nematodes.

Rock phosphate is a calcium or lime-based phosphate rock that is usually ground to the consistency of small crumbs. This rock powder contains over 30% phosphate and a large number of trace elements. Rock phosphate does not leach out of the soil, remaining unchanged until taken up by the roots.

Greensand is an iron potassium silicate that gives the minerals in which it occurs a green tint. Mined from an ancient New Jersey sea bed deposit of shells, Greensand is rich in iron, potassium and numerous micronutrients.

Fish emulsion is a partially decomposed blend of finely pulverized fish. It can smell, although some deodorized versions have been developed. Like blood meal, it should be used sparingly in order not to burn plant roots.

In one embodiment, humic acid is 50% by weight, microbes 25% and a binder of 25% is formed at 30 deg. C. In another embodiment, humic acid is 70% by weight, microbes 20% by weight and a binder of 10% by weight is formed at 30 deg. C. In another embodiment, humic acid is 50%, microbes 25% and a binder of 25% is formed 50-60 deg. In another embodiment, humic acid is 70% by weight, microbes 20% by weight and a binder of 10% is formed 30 deg. C.

The instant solids or pellets can be inserted into the ground using a planter, or a farm implement, usually towed behind a tractor, that sows (plants) seeds in rows throughout a field. It is connected to the tractor with a drawbar or a three-point hitch. Planters lay the seeds down in precise manner along rows. Planters vary greatly in size, from 1 row to 54, with the biggest in the world being the 48-row John Deere DB120. Some planters comprise multiple modules called row units. The row units are spaced evenly along the planter at intervals that vary widely by crop and locale. Various machines meter out the pellet and/or seed for sowing in rows. The ones that handle larger pellets/seeds tend to be called planters, whereas the ones that handle smaller seeds tend to be called seed drills, grain drills, and seeders (including precision seeders). They all share a set of similar concepts in the ways that they work, but there is established usage in which the machines for sowing some crops including maize (corn), beans, and peas are mostly called planters, whereas those that sow cereals are drills.

On smaller and older planters, a marker extends out to the side half the width of the planter and creates a line in the field where the tractor should be centered for the next pass. The marker is usually a single disc harrow disc on a rod on each side of the planter. On larger and more modern planters, GPS navigation and auto-steer systems for the tractor are often used, eliminating the need for the marker. Some precision farming equipment such as Case IH AFS uses GPS/RKS and computer-controlled planter to sow seeds to precise position accurate within 2 cm. In an irregularly shaped field, the precision farming equipment will automatically hold the seed release over area already sewn when the tractor has to run overlapping pattern to avoid obstacles such as trees.

The above description is for the purpose of illustrating and not limiting the present invention, and teaching the person of ordinary skill in the art how to practice the invention. It is not intended to detail all those obvious modifications and variations of it which will become apparent to the skilled worker upon reading the description. It is intended, however, that all such obvious modifications and variations be included within the scope of the present invention as defined in the appended claims. The claims are meant to cover the claimed components and steps in any sequence which is effective to meet the objectives there intended, unless the context specifically indicates the contrary. The patents, papers, and book excerpts cited above are hereby incorporated herein by reference in in their entireties.

What is claimed is:

1. A method to provide plant nutrient, comprising:
selecting a series of microbes optimal for plant growing;
mixing the microbes, urea and humic acid in a mixture; and
combining the mixture with a fertilizer.

2. The method of claim 1, wherein the fertilizer is a liquid and the mixture is a liquid, comprising mixing the liquid as a solution.

3. The method of claim 1, wherein the fertilizer is a powder and the mixture is a powder, comprising mixing the fertilizer and mixture powders.

4. The method of claim 1, wherein the fertilizer is a granular form and the mixture is a liquid, comprising coating the fertilizer with the mixture.

5. The method of claim 1, w wherein the fertilizer is a powder and the mixture is a powder, comprising mixing the fertilizer and mixture powders and extruding the powders as a pellet or a granular form.

6. The method of claim 1, wherein the fertilizer comprises an inorganic fertilizer.

7. The method of claim 6, wherein the inorganic fertilizer comprises ammonium nitrate, NPK (nitrogen, potassium, nitrate).

8. The method of claim 1, wherein the fertilizer comprises an organic fertilizer.

9. The method of claim 8, wherein the organic fertilizer comprises compost, manure, blood meal, bone meal, bat guano, shellfish, rock phosphate, greensand, fish emulsion, fish meal, and chitin.

10. The method of claim 1, comprising:
selecting a microbial solution with predetermined characteristics for agriculture use;
iteratively and selectively breeding generations of microbes for microbial strain selection with predetermined microbial gene profiles to arrive at a predetermined microbial solution in a highly concentrated form of at least 1×10⁷ cfu/ml (colony-forming units per milliliter), wherein multiple single microbial series are separately cultivated and followed with cross cultivation among the microbial series in a specific sequence; and
mixing by-products produced by the crossly cultivated microbial series with a soil amendment or nutrient.

11. The method of claim 1, comprising providing a liquid to the solid during use and binding the mixed by-products including humic acid to soil.

12. The method of claim 1, comprising forming a solid or a pellet from the mixed by-products.

13. The method of claim 1, wherein the fertilizer comprises an inorganic fertilizer including one of: Anhydrous Ammonia, Aqua Ammonia, Ammonium Nitrate, Ammonium Nitrate Solution, Ammonium Nitrate-Limestone Mixtures, Ammonium Nitrate—Sulfate, Ammonium Polysulfide, Ammonium Sulfate, Ammonium Sulfate Solution, Ammonium Sulfate—Nitrate, Ammonium Sulfate—Urea, Ammonium Thiosulfate, Calcium Ammonium Nitrate, Calcium Cyanamide, Calcium Nitrate, Calcium Nitrate—Urea, Ferrous Ammonium Sulfate, Magnesium Nitrate, Nitric Acid, Nitrogen, Sodium Nitrate, Sulfur Urea, Urea Solution, Urea—Formaldehyde, Zinc Ammonium Sulfate Solution, Zinc Manganese Sulfate, Nitrogen, Ammonium Metaphosphate, Ammonium Phosphate, Diammonium Phosphate, Ammonium Polyphosphate, Basic Lime Phosphate, Ammonium Phosphate Nitrate, Ammonium Phosphate Sulfate, Basic Slag, Monoammonium Phosphate, Bone Black Spent, Bone Meal, Raw, Bone Meal, Steamed, Bone, Precipitated, Calcium Metaphosphate, Colloidal Phosphate, Limestone, Phosphatic, Magnesium Phosphate, Nitric Phosphate, Phosphate Rock, Phosphoric Acid, Liquid Ammonium Polyphosphate, Precipitated Phosphate, Superphosphate, Normal, Superphosphate, Enriched, Superphosphate, Triple, Superphosphoric Acid, Phosphate Product, Phosphate, Lime-Potash Mixtures, Manure Salts, Potash Suspensions, Potassium Carbonate, Muriate of Potash, Potassium—Magnesium Sulfate, Potassium—Metaphosphate, Potassium Nitrate, Potassium—Sodium Nitrate, Potassium Sulfate, Tobacco Stems, Potash, Blood, Dried, Castor Pomace, Cocoa Shell Meal, Cocoa Tankage, Compost, Cottonseed Meal, Fish Scrap, Guano, Manure, Peat, Sewage Sludge, Activated, Sewage Sludge, Heat-Dried, Sewage Sludge, Other, Soybean Meal, Tankage, Animal, Tankage, Process, Linseed Meal, Tung Pumace, Aluminum Sulfate, Borax, Brucite or Magnesium Hydroxide, Cobalt Sulfate, Copper Oxide, Black, Copper Oxide, Red, Copper Sulfate, Copper Chelate, Copper Compound, Ferric Oxide, Ferric Sulfate, Ferrous Sulfate, Iron Chelate, Iron Compound, Gypsum or Calcium Sulfate, Calcium Chelate, Calcium Sulfate, Lime Sulfur Solution, Magnesia or Magnesium Oxide, Epsom Salt or Magnesium Sulfate, Magnesium Chelate, Manganese Agstone, Manganese Chelate, Manganese Oxide, Manganese Slag, Manganese Sulfate, Manganous Oxide, Sodium Molybdonate, Soil Additive, Soil Conditioner, Potting Soil, Sulfur, Calcium Chloride, Sulfuric Acid, Zinc Oxide, Zinc Oxysulfate, Zinc Sulfate, Zinc Sulfate Solution, Zinc Chelate, Calcium Oxide, Dolomite, Dolomitic Lime, Standard Calcite, Lime, Dolomitic & Calcitic Blend, Lime Suspensions, Water, Sand, and Non-Lime Filler.

14. The method of claim 1, comprising selecting the microbe from one of: Bacillus (B.) acidiceler,B. acidicola, B. acidiproducens, B. acidocaldarius, B. acidoterrestrisr, B. aeolius, B. aerius, B. aerophilus, B. agaradhaerens, B. agri, B. aidingensis, B. akibai, B. alcalophilus, B. algicola, B. alginolyticus, B. alkalidiazotrophicus, B. alkalinitrilicus, B. alkalisediminis, B. alkalitelluris, B. altitudinis, B. alveayuensis, B. alvei, B. amyloliquefaciens, B. a. subsp. amyloliquefaciens, B. a. subsp. plantarum, B. amylolyticus, B. andreesenii, B. aneurinilyticus, B. anthracia, B. aquimaris, B. arenosi, B. arseniciselenatis, B. arsenicus, B. aurantiacus, B. arvi, B. aryabhattai, B. asahii, B. atrophaeus, B. axarquiensis, B. azotofixans, B. azotoformans, B. badius, B. barbaricus, B. bataviensis, B. beijingensis, B. benzoevorans, B. beringensis, B. berkeleyi, B. beveridgei, B. bogoriensis, B. boroniphilus, B. borstelensis, B. brevis Migula, B. butanolivorans, B. canaveralius, B. carboniphilus, B. cecembensis, B. cellulosilyticus, B. centrosporus, B. cereus, B. chagannorensis, B. chitinolyticus, B. chondroitinus, B. choshinensis, B. chungangensis, B. cibi, B. circulans, B. clarkii, B. clausii, B. coagulans, B. coahuilensis, B. cohnii, B. composti, B. curdlanolyticus, B. cycloheptanicus, B. cytotoxicus, B. daliensis, B. decisifrondis, B. decolorationis, B. deserti, B. dipsosauri, B. drentensis, B. edaphicus, B. ehimensis, B. eiseniae, B. enclensis, B. endophyticus, B. endoradicis, B. farraginis, B. fastidiosus, B. fengqiuensis, B. firmus, B. flexus, B. foraminis, B. fordii, B. formosus, B. fortis, B. fumarioli, B. funiculus, B. fusiformis, B. galactophilus, B. galactosidilyticus, B. galliciensis, B. gelatini, B. gibsonii, B. ginsengi, B. ginsengihumi, B. ginsengisoli, B. globisporus, B. g. subsp. globisporus, B. g. subsp. marinus, B. glucanolyticus, B. gordonae, B. gottheilii, B. graminis, B. halmapalus, B. haloalkaliphilus, B. halochares, B. halodenitrificans, B. halodurans, B. halophilus, B. halosaccharovorans, B. hemicellulosilyticus, B. hemicentroti, B. herbersteinensis, B. horikoshii, B. horneckiae, B. horti, B. huizhouensis, B. humi, B. hwajinpoensis, B. idriensis, B. indicus, B. infantis, B. infernus, B. insolitus, B. invictae, B. iranensis, B. isabeliae, B. isronensis, B. jeotgali, B. kaustophilus, B. kobensis, B. kochii, B. kokeshiiformis, B. koreensis, B. korlensis, B. kribbensis, B. krulwichiae, B. laevolacticus, B. larvae, B. laterosporus, B. lautus, B. lehensis, B. lentimorbus, B. lentus, B. licheniformis, B. ligniniphilus, B. litoralis, B. locisalis, B. luciferensis, B. luteolus, B. luteus, B. macauensis, B. macerans, B. macquariensis, B. macyae, B. malacitensis, B. mannanilyticus, B. marisflavi, B. marismortui, B. marmarensis, B. massiliensis, B. megaterium, B. mesonae, B. methanolicus, B. methylotrophicus, B. migulanus, B. mojavensis, B. mucilaginosus, B. muralis, B. murimartini, B. mycoides, B. naganoensis, B. nanhaiensis, B. nanhaiisediminis, B. nealsonii, B. neidei, B. neizhouensis, B. niabensis, B. niacini, B. novalis, B. oceanisediminis, B. odysseyi, B. okhensis, B. okuhidensis, B. oleronius, B. oryzaecorticis, B. oshimensis, B. pabuli, B. pakistanensis, B. pallidus, B. pallidus, B. panacisoli, B. panaciterrae, B. pantothenticus, B. parabrevis, B. paraflexus, B. pasteurii, B. patagoniensis, B. peoriae, B. persepolensis, B. persicus, B. pervagus, B. plakortidis, B. pocheonensis, B. polygoni, B. polymyxa, B. popilliae, B. pseudalcalophilus, B. pseudofirmus, B. pseudomycoides, B. psychrodurans, B. psychrophilus, B. psychrosaccharolyticus, B. psychrotolerans, B. pulvifaciens, B. pumilus, B. purgationiresistens, B. pycnus, B. qingdaonensis, B. qingshengii, B. reuszeri, B. rhizosphaerae, B. rigui, B. ruris, B. safensis, B. salarius, B. salexigens, B. saliphilus, B. schlegelii, B. sediminis, B. selenatarsenatis, B. selenitireducens, B. seohaeanensis, B. shacheensis, B. shackletonii, B. siamensis, B. silvestris, B. simplex, B. siralis, B. smithii, B. soli, B. solimangrovi, B. solisalsi, B. songklensis, B. sonorensis, B. sphaericus, B. sporothermodurans, B. stearothermophilus, B. stratosphericus, B. subterraneus, B. subtilis, B. s. subsp. inaquosorum, B. s. subsp. spizizenii, B. s. subsp. subtilis, B. taeanensis, B. tequilensis, B. thermantarcticus, B. thermoaerophilus, B. thermoamylovorans, B. thermocatenulatus, B. thermocloacae, B. thermocopriae, B. thermodenitrificans, B. thermoglucosidasius, B. thermolactis, B. thermoleovorans, B. thermophilus, B. thermoruber, B. thermosphaericus, B. thiaminolyticus, B. thioparans, B. thuringiensis, B. tianshenii, B. trypoxylicola, B. tusciae, B. validus, B. vallismortis, B. vedderi, B. velezensis, B. vietnamensis, B. vireti, B. vulcani, B. wakoensis, B. weihenstephanensis, B. xiamenensis, B. xiaoxiensis, and B. zhanjiangensis.

15. A system to enhance soil, comprising:
a fertilizer; and
a mixture of microbes, urea and humic acid formed as a coating on the fertilizer or embedded with the fertilizer in powder, pellet, or granular form.

16. The system of claim 11, wherein the microbes comprise a member of Bacillus.

17. The system of claim 11, wherein the microbes comprise one or more of: Bacillus (B.) acidiceler,B. acidicola, B. acidiproducens, B. acidocaldarius, B. acidoterrestrisr, B. aeolius, B. aerius, B. aerophilus, B. agaradhaerens, B. agri, B. aidingensis, B. akibai, B. alcalophilus, B. algicola, B. alginolyticus, B. alkalidiazotrophicus, B. alkalinitrilicus, B. alkalisediminis, B. alkalitelluris, B. altitudinis, B. alveayuensis, B. alvei, B. amyloliquefaciens, B. a. subsp. amyloliquefaciens, B. a. subsp. plantarum, B. amylolyticus, B. andreesenii, B. aneurinilyticus, B. anthracia, B. aquimaris, B. arenosi, B. arseniciselenatis, B. arsenicus, B. aurantiacus, B. arvi, B. aryabhattai, B. asahii, B. atrophaeus, B. axarquiensis, B. azotofixans, B. azotoformans, B. badius, B. barbaricus, B. bataviensis, B. beijingensis, B. benzoevorans, B. beringensis, B. berkeleyi, B. beveridgei, B. bogoriensis, B. boroniphilus, B. borstelensis, B. brevis Migula, B. butanolivorans, B. canaveralius, B. carboniphilus, B. cecembensis, B. cellulosilyticus, B. centrosporus, B. cereus, B. chagannorensis, B. chitinolyticus, B. chondroitinus, B. choshinensis, B. chungangensis, B. cibi, B. circulans, B. clarkii, B. clausii, B. coagulans, B. coahuilensis, B. cohnii, B. composti, B. curdlanolyticus, B. cycloheptanicus, B. cytotoxicus, B. daliensis, B. decisifrondis, B. decolorationis, B. deserti, B. dipsosauri, B. drentensis, B. edaphicus, B. ehimensis, B. eiseniae, B. enclensis, B. endophyticus, B. endoradicis, B. farraginis, B. fastidiosus, B. fengqiuensis, B. firmus, B. flexus, B. foraminis, B. fordii, B. formosus, B. fortis, B. fumarioli, B. funiculus, B. fusiformis, B. galactophilus, B. galactosidilyticus, B. galliciensis, B. gelatini, B. gibsonii, B. ginsengi, B. ginsengihumi, B. ginsengisoli, B. globisporus, B. g. subsp. globisporus, B. g. subsp. marinus, B. glucanolyticus, B. gordonae, B. gottheilii, B. graminis, B. halmapalus, B. haloalkaliphilus, B. halochares, B. halodenitrificans, B. halodurans, B. halophilus, B. halosaccharovorans, B. hemicellulosilyticus, B. hemicentroti, B. herbersteinensis, B. horikoshii, B. horneckiae, B. horti, B. huizhouensis, B. humi, B. hwajinpoensis, B. idriensis, B. indicus, B. infantis, B. infernus, B. insolitus, B. invictae, B. iranensis, B. isabeliae, B. isronensis, B. jeotgali, B. kaustophilus, B. kobensis, B. kochii, B. kokeshiiformis, B. koreensis, B. korlensis, B. kribbensis, B. krulwichiae, B. laevolacticus, B. larvae, B. laterosporus, B. lautus, B. lehensis, B. lentimorbus, B. lentus, B. licheniformis, B. ligniniphilus, B. litoralis, B. locisalis, B. luciferensis, B. luteolus, B. luteus, B. macauensis, B. macerans, B. macquariensis, B. macyae, B. malacitensis, B. mannanilyticus, B. marisflavi, B. marismortui, B. marmarensis, B. massiliensis, B. megaterium, B. mesonae, B. methanolicus, B. methylotrophicus, B. migulanus, B. mojavensis, B. mucilaginosus, B. muralis, B. murimartini, B. mycoides, B. naganoensis, B. nanhaiensis, B. nanhaiisediminis, B. nealsonii, B. neidei, B. neizhouensis, B. niabensis, B. niacini, B. novalis, B. oceanisediminis, B. odysseyi, B. okhensis, B. okuhidensis, B. oleronius, B. oryzaecorticis, B. oshimensis, B. pabuli, B. pakistanensis, B. pallidus, B. pallidus, B. panacisoli, B. panaciterrae, B. pantothenticus, B. parabrevis, B. paraflexus, B. pasteurii, B. patagoniensis, B. peoriae, B. persepolensis, B. persicus, B. pervagus, B. plakortidis, B. pocheonensis, B. polygoni, B. polymyxa, B. popilliae, B. pseudalcalophilus, B. pseudofirmus, B. pseudomycoides, B. psychrodurans, B. psychrophilus, B. psychrosaccharolyticus, B. psychrotolerans, B. pulvifaciens, B. pumilus, B. purgationiresistens, B. pycnus, B. qingdaonensis, B. qingshengii, B. reuszeri, B. rhizosphaerae, B. rigui, B. ruris, B. safensis, B. salarius, B. salexigens, B. saliphilus, B. schlegelii, B. sediminis, B. selenatarsenatis, B. selenitireducens, B. seohaeanensis, B. shacheensis, B. shackletonii, B. siamensis, B. silvestris, B. simplex, B. siralis, B. smithii, B. soli, B. solimangrovi, B. solisalsi, B. songklensis, B. sonorensis, B. sphaericus, B. sporothermodurans, B. stearothermophilus, B. stratosphericus, B. subterraneus, B. subtilis, B. s. subsp. inaquosorum, B. s. subsp. spizizenii, B. s. subsp. subtilis, B. taeanensis, B. tequilensis, B. thermantarcticus, B. thermoaerophilus, B. thermoamylovorans, B. thermocatenulatus, B. thermocloacae, B. thermocopriae, B. thermodenitrificans, B. thermoglucosidasius, B. thermolactis, B. thermoleovorans, B. thermophilus, B. thermoruber, B. thermosphaericus, B. thiaminolyticus, B. thioparans, B. thuringiensis, B. tianshenii, B. trypoxylicola, B. tusciae, B. validus, B. vallismortis, B. vedderi, B. velezensis, B. vietnamensis, B. vireti, B. vulcani, B. wakoensis, B. weihenstephanensis, B. xiamenensis, B. xiaoxiensis, and B. zhanjiangensis.

18. The system of claim 15, wherein the fertilizer comprises one of: organic fertilizer, compost, manure, blood meal, bone meal, bat guano, shellfish, rock phosphate, greensand, fish emulsion, fish meal, and chitin.

19. The system of claim 15, wherein the fertilizer comprises one of: an inorganic fertilizer, Anhydrous Ammonia, Aqua Ammonia, Ammonium Nitrate, Ammonium Nitrate Solution, Ammonium Nitrate-Limestone Mixtures, Ammonium Nitrate—Sulfate, Ammonium Polysulfide, Ammonium Sulfate, Ammonium Sulfate Solution, Ammonium Sulfate Nitrate, Ammonium Sulfate—Urea, Ammonium Thiosulfate, Calcium Ammonium Nitrate, Calcium Cyanamide, Calcium Nitrate, Calcium Nitrate—Urea, Ferrous Ammonium Sulfate, Magnesium Nitrate, Nitric Acid, Nitrogen, Sodium Nitrate, Sulfur Urea, Urea Solution, Urea—Formaldehyde, Zinc Ammonium Sulfate Solution, Zinc Manganese Sulfate, Nitrogen, Ammonium Metaphosphate, Ammonium Phosphate, Diammonium Phosphate, Ammonium Polyphosphate, Basic Lime Phosphate, Ammonium Phosphate Nitrate, Ammonium Phosphate Sulfate, Basic Slag, Monoammonium Phosphate, Bone Black Spent, Bone Meal, Raw, Bone Meal, Steamed, Bone, Precipitated, Calcium Metaphosphate, Colloidal Phosphate, Limestone, Phosphatic, Magnesium Phosphate, Nitric Phosphate, Phosphate Rock, Phosphoric Acid, Liquid Ammonium Polyphosphate, Precipitated Phosphate, Superphosphate, Normal, Superphosphate, Enriched, Superphosphate, Triple, Superphosphoric Acid, Phosphate Product, Phosphate, Lime-Potash Mixtures, Manure Salts, Potash Suspensions, Potassium Carbonate, Muriate of Potash, Potassium—Magnesium Sulfate, Potassium—Metaphosphate, Potassium Nitrate, Potassium—Sodium Nitrate, Potassium Sulfate, Tobacco Stems, Potash, Blood, Dried, Castor Pomace, Cocoa Shell Meal, Cocoa Tankage, Compost, Cottonseed Meal, Fish Scrap, Guano, Manure, Peat, Sewage Sludge, Activated, Sewage Sludge, Heat-Dried, Sewage Sludge, Other, Soybean Meal, Tankage, Animal, Tankage, Process, Linseed Meal, Tung Pumace, Aluminum Sulfate, Borax, Brucite or Magnesium Hydroxide, Cobalt Sulfate, Copper Oxide, Black, Copper Oxide, Red, Copper Sulfate, Copper Chelate, Copper Compound, Ferric Oxide, Ferric Sulfate, Ferrous Sulfate, Iron Chelate, Iron Compound, Gypsum or Calcium Sulfate, Calcium Chelate, Calcium Sulfate, Lime Sulfur Solution, Magnesia or Magnesium Oxide, Epsom Salt or Magnesium Sulfate, Magnesium Chelate, Manganese Agstone, Manganese Chelate, Manganese Oxide, Manganese Slag, Manganese Sulfate, Manganous Oxide, Sodium Molybdonate, Soil Additive, Soil Conditioner, Potting Soil, Sulfur, Calcium Chloride, Sulfuric Acid, Zinc Oxide, Zinc Oxysulfate, Zinc Sulfate, Zinc Sulfate Solution, Zinc Chelate, Calcium Oxide, Dolomite, Dolomitic Lime, Standard Calcite, Lime, Dolomitic & Calcitic Blend, Lime Suspensions, Water, Sand, and Non-Lime Filler.

20. The system of claim 15, wherein the fertilizer comprises a seed coating.
